(19) United States
(12) Patent Application Publication
(10) Pub. No.: US 2011/0214981 A1
(43) Pub. Date: Sep. 8, 2011

(54) Process For The Purification Of Methanol By Distillation

(75) Inventor: Simon Robert Early, London (GB)

(73) Assignee: DAVY PROCESS TECHNOLOGY LIMITED, London, GB (GB)

(21) Appl. No.: 13/061,917

(22) PCT Filed: Aug. 28, 2009
(86) PCT No.: PCT/GB09/51086

§ 371 Date: May 24, 2011

(30) Foreign Application Priority Data
Sep. 4, 2008 (GB) 0816095.4

(51) Int. Cl. B01D 3/34

(52) U.S. Cl. 203/37; 203/36

(57) ABSTRACT

In a process for distillation, in a distillation column, of a crude stream of methanol produced from synthesis gas, fusel oil is removed from the distillation column as a vapour side draw from a point in the distillation column below the feed, and the vapour side draw is substantially free of alkali. A process for the production of methanol utilising this distillation process is also described.

The present invention relates to a process for the purification of a crude methanol steam by distillation. In particular, it relates to an improved process for removing fusel oil from the crude methanol steam. In a further aspect, the present invention relates to a process for producing methanol.

Methanol is conventionally produced from synthesis gas which comprises hydrogen, carbon monoxide and carbon dioxide as the main components. These gases are reacted in the presence of a suitable catalyst at suitable temperatures and pressures for the production of methanol. In one arrangement the catalyst may be a copper-containing catalyst and suitable temperatures are from about 200° C. to about 300° C. and suitable pressures include those of from about 50 to about 150 atm. The reaction is usually carried out in the presence of a large quantity of steam. Water is formed as a by-product of the reaction. The crude product in liquid form is then usually subjected to distillation to separate the methanol from the water and by-products. The by-products include those having a higher boiling point that methanol.

Typically fusel oil is produced as a by-product in the reaction. Fusel oil, also known as fusel alcohol, is a mixture of alcohols having more than two carbon atoms. Generally, “fusel oil” will include 1-propanol, 2-propanol, various isomers of butanol, amyl alcohol and furfural. On a typical methanol plant the distillation column includes a side draw as a purge taken near to the bottom of the column, which is generally a low pressure distillation column, used to separate the water and methanol. This side draw, which will include water and methanol, removes the fusel oil as a liquid.

Conventionally a weak solution of an alkali, generally sodium hydroxide, is added to the crude methanol prior to the distillation column, or where there is more than one column prior to the first distillation column. The alkali is added for a number of reasons. The main benefit it provides is to reduce corrosion rates so that carbon steel can be used in the distillation section of the plant. In addition, the alkali, such as sodium hydroxide reacts with the low concentrations of organic acids which may be present in the crude methanol, trapping the acids in the liquid water and thereby reducing the concentration of the acids in the desired product methanol. The alkali stays dissolved in the liquid water and so is present in both the water removed from the bottom of the column and also in the fusel oil.

Once the fusel oil has been removed in a side draw, it will generally be fed to a saturator which is a packed column. Natural gas is passed up the saturator column which picks up steam from circulating hot water and, in a section located near to the top of the column picks up the organics from the fusel oil. However, it is not desirable to include a saturator column in many setups not least because of the increase in capital and running costs. Further the presence of alkali, such as sodium hydroxide, in the fusel oil stream leads to various problems in the saturator. In particular, fusel oil containing the alkali, such as sodium hydroxide, cannot be recycled directly to the methanol generation portion of the plant. In addition, residual effluent contaminated with alkali and organic compounds can present problems of disposal.

Various proposals have been made to address the problems associated with the presence of fusel oil and/or the need to add alkali to reduce the caustic nature of the distillation step. Indeed engineers have been struggling for many years with the problem of how to dispose of fusel oil contaminated with sodium hydroxide.

For example, in U.S. Pat. No. 5,387,322 a method for recovering volatile components in a stripper is described. In the process fusel oil is stripped with steam to produce an overhead vapour stream of steam and stripped organic components which can be recycled to the methanol production reactor.

As an alternative approach, in U.S. Pat. No. 5,063,250 the distillation process is carried out in a plant produced from stainless steel rather than the conventional carbon steel. Since stainless steel is used the problems associated with the corrosion of prior art systems is addressed and it is not necessary to add sodium hydroxide to deal with the corrosion issues. Since no sodium hydroxide is added the fusel stream does not contain sodium hydroxide thereby obviating the problems associated with fusel oil contaminated with sodium hydroxide.

However, this approach suffers from various disadvantages and drawbacks. For example, the change of construction material to stainless steel has a substantial impact on the cost of the plant. Further, this approach means that the trace levels of organic acids are not “trapped” in the liquid water and so will increase the contaminant level in the product methanol. In this connection it should be noted that for most commercial purposes, the methanol purity is a key factor in the viability of the process and any increase in organic acids in the product stream would not be acceptable.

A process is described in EP0040481 in which the fusel oil is removed either as a vapour draw above the position at which the feed enters the distillation column or as a liquid above the feed point. A similar teaching can be found in U.S. Pat. No. 715,119. Whilst these processes may offer some advantages, they still suffer from some disadvantages.

It is therefore desirable to provide an alternative solution to the long-held problem associated with the alkali which is present in the fusel oil removed from conventional processes.

It has now been discovered that the long-held problems can be obviated if the fusel oil is removed as a vapour side draw rather than a liquid side draw and that the vapour side draw is taken from the distillation column at a point below the feed. Thus according to the present invention there is provided a process for distillation, in a distillation column, of a crude stream of methanol produced from synthesis gas, said crude stream comprising fusel oil and alkali wherein said fusel oil is removed from the distillation column as a vapour side draw from a point in the distillation column below the feed and wherein said vapour side draw is substantially free of alkali.

The benefit of taking the vapour side draw from a point below the feed is that it will be free of substantially free of alkali. The vapour once removed may be condensed and the liquid fusel oil recovered and where appropriate recycled to the methanol production reactor. The alkali, being substantially non-volatile is retained in the liquid phase and therefore can only move downwardly in the column from the feed point.

In one arrangement, the alkali is sodium hydroxide.

The process of the present invention does not require the use of expensive materials in the production of the plant nor is there a requirement for a separate stripper or saturator to separate the fusel oil from the alkali.

It is acknowledged that it is known in distillation technology to take side draws from the vapour space such as between two distillation trays. Despite this, it has not been appreciated that fusel oil could be removed as a vapour side draw at a point below the feed to the column and that in doing so the problems associated with the presence of alkali in the fusel oil would be rendered moot. To date, all effort has been focused on either avoiding the use of alkali such as sodium hydroxide so that it is not present in the liquid side draw of the fusel oil or in treating the liquid side draw of fusel oil and alkali such as sodium hydroxide.

The removal of the fusel oil as a vapour side draw can be carried out by any suitable means. The means for taking a vapour side draw in a distillation column are well known from other distillation schemes. In one arrangement, the means utilised to remove the vapour side draw will be one which includes means for eliminating or minimising the withdrawal of liquid droplets entrained in the vapour. Thus in one arrangement, the apparatus will be designed to include a mist eliminator. These arrangements are well known to the skilled man.

According to a second aspect of the present invention there is provided a process for the production of methanol comprising the steps of:
(a) providing synthesis gas tonally with recycle streams to a methanol synthesis reactor;
(b) reacting synthesis gas in the presence of a methanol synthesis catalyst to synthesise crude methanol:
(e) recovering a crude methanol stream;
(d) contacting the crude methanol with an alkaline compound to neutralise organic acid;
(e) subjecting the crude methanol stream to distillation in accordance with the process of the first aspect of the present invention;
(f) recovering methanol; and
(g) recovering fusel oil as a vapour side draw.

According to a preferred aspect of the present invention the fusel oil recovered in step (g) is condensed and liquid fusel oil recycled to step (a).

1. A process for distillation, in a distillation column, of a crude stream of methanol produced from synthesis gas, said crude stream comprising fusel oil and alkali wherein said fusel oil is removed from the distillation column as a vapour side draw from a point in the distillation column below the feed and wherein said vapour side draw is substantially free of alkali.

2. A process according to claim 1 wherein the alkali is sodium hydroxide.

3. A process for the production of methanol comprising the steps of:
(a) providing synthesis gas optionally with recycle streams to a methanol synthesis reactor;
(b) reacting synthesis gas in the presence of a methanol synthesis catalyst to synthesise crude methanol:
(c) recovering a crude methanol stream;
(d) contacting the crude methanol with an alkaline compound to neutralise organic acid;
(e) subjecting the crude methanol stream to distillation in accordance with the process of claim 1:
(f) recovering methanol; and
(g) recovering fusel oil as a vapour side draw.

4. A process according to claim 3 wherein the alkali in the crude stream is sodium hydroxide.

5. A process according to claim 3 wherein the fusel oil recovered in step (g) is condensed and liquid fusel oil is recycled to step (a).
